(19) United States
(12) Patent Application Publication
(10) Pub. No.: US 2013/0213068 A1
(43) Pub. Date: Aug. 22, 2013

(54) SAFE OPERATION OF SPACE CONDITIONING SYSTEMS USING FLAMMABLE REFRIGERANTS

(71) Applicants: Rakesh Goel, Irving, TX (US); Shailesh Manohar, Coppell, TX (US)

(72) Inventors: Rakesh Goel, Irving, TX (US); Shailesh Manohar, Coppell, TX (US)

(21) Appl. No.: 13/401,430

(22) Filed: Feb. 21, 2012

(51) Int. Cl. F25B 49/00; B23P 15/26

(52) U.S. Cl. 62/129; 29/890.035

(57) ABSTRACT

A space conditioning system for conditioning air within an enclosed space. The system comprises a refrigeration subsystem configured to circulate a flammable refrigerant there-through. The refrigeration subsystem also comprises a safety module configured to include either: a leak-detector subunit, or, a start-up subunit. The leak-detector subunit is configured to monitor for a leak of the flammable refrigerant from the refrigeration subsystem, and, to generate an alarm signal if the leak is detected. The start-up subunit is configured to turn on one or more airflow devices configured to vent or mix a leaked flammable refrigerant.

### TECHNICAL FIELD

This application is directed, in general, to space conditioning systems and method for conditioning the temperature and humidity of an enclosed space and, in particular, conditioning systems designed to using flammable refrigerants.

### BACKGROUND

The cooling industry may be forced by regulation to move towards low global warming potential refrigerants. At least some promising low global warming potential refrigerants are flammable. Flammable refrigerants present a number of challenges that are contra-indictors of their use, however. Space conditioning systems with furnace heating can generate surface temperatures that are high enough to ignite leaked flammable refrigerants within the furnace or nearby. Residential space conditioning systems can have a refrigerant charge that is large enough to easily reach lower flammability limits if a flammable refrigerant were to leak. Consequently, to meet safety standards, the allowable charge of flammable refrigerant would make their use impractical for many space conditioning applications.

### SUMMARY

One embodiment of the present disclosure is a space conditioning system for conditioning air within an enclosed space. The system comprises a refrigeration subsystem configured to circulate a flammable refrigerant there-through. The refrigeration subsystem also comprises a safety module configured to include either: a leak-detector subunit, or, a start-up subunit. The leak-detector subunit is configured to monitor for a leak of the flammable refrigerant from the refrigeration subsystem, and, to generate an alarm signal if the leak is detected. The start-up subunit is configured to turn on one or more airflow devices configured to vent or mix a leaked flammable refrigerant.

Another embodiment of the present disclosure is a method of assembling a space conditioning system. The method comprises providing a refrigeration subsystem configured to circulate a flammable refrigerant there-through. The method also comprises providing a safety module that includes either: the above-described leak-detector subunit, or, the above described start-up subunit.

Another embodiment of the present disclosure is a method of conditioning air within an enclosed space. The method comprises circulating a flammable refrigerant though a refrigeration subsystem, and, either: monitoring for a leakage of the flammable refrigerant from the refrigeration subsystem and generating an alarm signal if the leak is detected, or, commencing a start-up sequence to turn on one or more airflow devices configured to vent or mix a leaked flammable refrigerant.

### BRIEF DESCRIPTION OF THE DRAWINGS

Reference is now made to the following descriptions taken in conjunction with the accompanying drawings, in which:

FIG. 1 presents block diagram of an example embodiment of selected components of a space conditioning system of the disclosure;

FIG. 2 presents a flow diagram of an example method of assembling a space conditioning system such as any embodiments of the space conditioning systems discussed in the context of FIG. 1; and

FIG. 3 presents a flow diagram of an example method of conditioning air within an enclosed space, such as implemented by any of the embodiments of the space conditioning systems discussed in the context of FIGS. 1 and 2.

### DETAILED DESCRIPTION

Embodiments of the present disclosure provide a space conditioning system for conditioning air within an enclosed space and methods of safety operating the system using flammable refrigerants, preferably having a low global warming potential. The safe operation of such a system is facilitated by running a start-up sequence to turn on one or more airflow devices configured to vent or mix a leaked flammable refrigerant, or, by monitoring for a leak of the flammable refrigerant from the refrigeration subsystem of the space conditioning system and generating an alarm when a leak is detected. In various cases, counter measures can be taken, to prevent or limit the amount of flammable refrigerant that could be ignited.

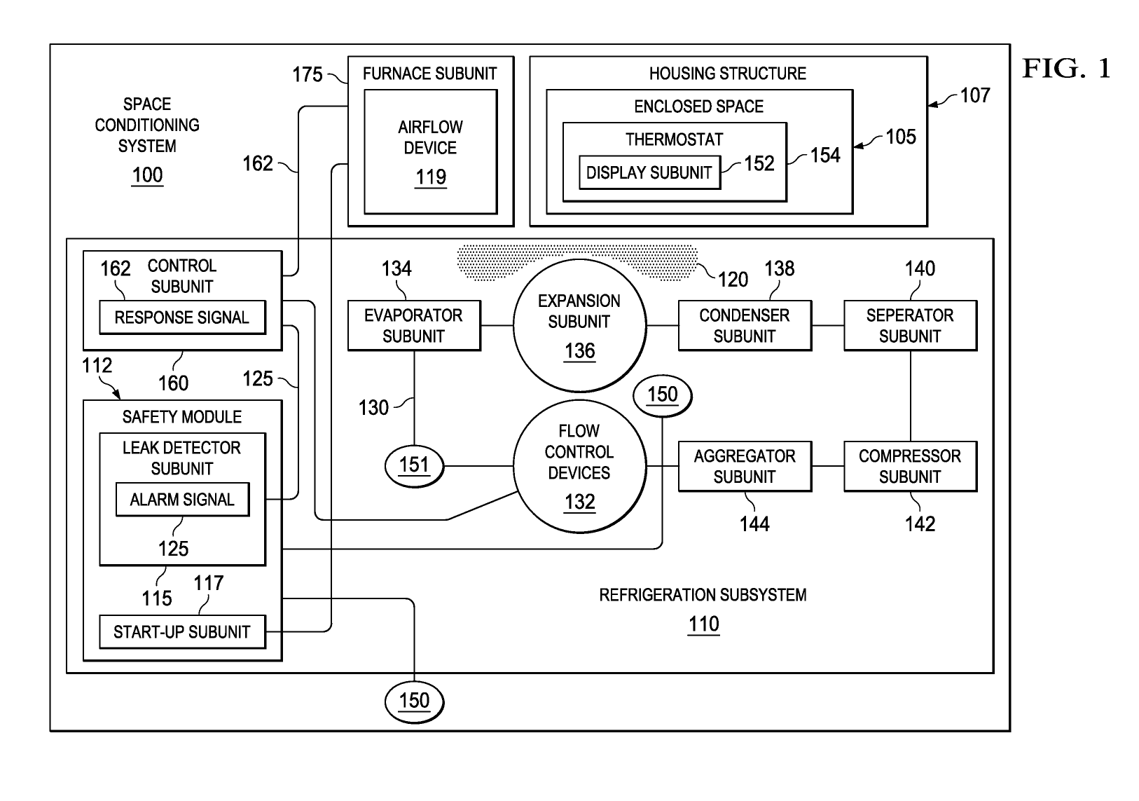

One embodiment of the present is a disclosure space conditioning system. FIG. 1 presents a block diagram of an example embodiment of selected components of a space conditioning system 100 of the disclosure.

The system 100, for conditioning air within an enclosed space 105 (e.g., inside of a housing structure 107), comprises a refrigeration subsystem 110 and safety module 112. The safety module 112 includes either a leak-detector subunit 115 or a start-up subunit 117.

The refrigeration subsystem 110 is configured to circulate a flammable refrigerant 120 there-through. The leak-detector subunit 115 is configured to monitor for a leak of the flammable refrigerant 120 from the refrigeration subsystem 110, and, to generate an alarm signal 125 if the leak is detected. The start-up subunit 117 is configured to turn on one or more air mover devices 119 that, in turn, are configured to vent or mix a leaked flammable refrigerant.

The enclosed space 105 whose air is conditioned by the system 100 may be the interior space of a structure 107 such as a building, home, or vehicle. In some embodiments, the refrigeration subsystem 110 can be configured as an air-conditioning system for the building, home or motor vehicle. In other embodiments the enclosed space 105 can be the cooling compartment or compartments inside of a freezer or refrigerator 107, and, the refrigeration subsystem 110 is configured to cool such a refrigeration device 107.

The term refrigeration subsystem 110 as used herein refers to any device, or collection of subunit devices, and their associated flow lines 130 and flow control devices 132 (e.g., valves), configured to flow flammable refrigerants there-through to facilitate cooling of the enclosed space 105. For instance, in some embodiments, the refrigeration subsystem 110 can include one or more evaporator subunits 134, expansion device subunits 136, condenser subunits 138, separator subunit 140, compressor subunits 142, aggregator subunit 144, or other components familiar to those of ordinary skill in the art. The leak-detector subunit 115 or its component sensors 150, 151 could be located in the vicinity (e.g., adjacent to or in some cases inside) of any or all of these subunits devices of the subsystem 110.

The term, flammable refrigerant, as used herein, is defined as refrigerants in class 2, 3, or subclasses thereof, as defined “Designation and Safety Classification of Refrigerants,” published by the American Society of Heating Refrigerating and Air-Conditioning Engineers (ASHRAE) Inc. Standard 34-2007, in Section 6.1.3 and other section referenced therein, 2010, which is incorporated by reference herein in its entirety.

In some embodiments, the safety module 112 includes both the leak-detector subunit 115 and the start-up subunit 117. For example, some such embodiments advantageously provide a second measure to mitigate against the combustion of leaked flammable refrigerant 120, if the start-up subunit 117, or the airflow device 119, malfunctions or is unable to reduce the gaseous concentration of flammable refrigerant 120 below a flammability limit, e.g., because of a large leakage of the flammable refrigerant 120.

In some embodiments, the start-up subunit 117 is configured turn on the one more airflow devices 119 prior to activating any components of the space conditioning system 100, or other nearby devices not part of the system 100 (e.g., a water heater) that could ignite the flammable refrigerant. Such components, or other device, could include components or devices that generate a flame or spark, or, heat up sufficiently to cause the flammable refrigerant to combust. In some cases, the start-up subunit 117 is configured to turn on the one more airflow devices 119 for a time period (e.g., in a range from about 10 seconds to about 1 minute, from 1 minute to about 2 minutes, or from 2 minutes to about 10 minutes, in some cases) that is sufficient to reduce a gaseous flammable refrigerant concentration outside of the refrigeration subsystem to below a flammability limit, such as set by a standards body such as ASHRAE.

In some cases the alarm signal 125 could be or include an audio or visual display to alert the human occupant of the enclosed space 105 and/or operator of the system 100. For instance, in some cases, the alarm signal 125 is configured to cause a display subunit 152 of the system 100 to present an alarm indication. For instance, the alarm indication can be a visual and/or audio message presented on the display 152 located on an external surface of the refrigeration subsystem 110, or, a display located in the conditioned space 105 such as a display of a programmable thermostat 154 of the system 100. For instance, in such cases, the occupant or operator can then decide what actions to take to mitigate the risk of the flammable refrigerant 120 being ignited.

In other cases, it can be advantageous to configure the leak detector 115 to initiate one or more automated responses to the alarm signal 125 so as to prevent fire or other damage from the leaking flammable refrigerant 120 even when the space conditioning system 100 is not monitored by a human operator or the enclosed space 105 is not occupied.

For instance, in some embodiments, the system 100 further includes a control subunit 160 configured to receive the alarm signal 125, and, to generate a response signal 162 after receiving the alarm signal 125. In some embodiments, the control subunit 160 can be or include one or more electrical circuits configured to receive the alarm signal 125 (e.g., sent as an electrical signal) via a receiver circuit that is wired, or wirelessly, connected to the leak-detector subunit, and a transmitter circuit that is configured to send the response signal 162 to other components of the system 100

In some cases, the response signal 162 can be configured to cause the flammable refrigerant 120 to have reduced circulation, up to and including a complete cessation of flow, through the refrigeration subsystem 110. For instance, the response signal 162 can cause flow control devices 132 to turn off refrigerant's flow through flow lines 130 or other device subunits of the subsystem 110, to reduce further leakage of the refrigerant 120.

In some embodiments, the response signal 162 can be configured to cause a charge of the flammable refrigerant 120 to become inaccessible to a part of the refrigeration subsystem 110. e.g., the part of the subsystem 110 where the alarm signal 125 originated from. For instance the response signal 162 can cause flow control devices 132 to limit the available refrigerant charge by closing off part of refrigeration system 110 such that the part of the system with the detected leak is isolated from the rest of the refrigeration subsystem 110. For instance the response signal 162 can cause a stoppage of electrical power to device subunits of the subsystem 110.

In some embodiments, the response signal 162 can be configured to cause the flammable refrigerant 120 to be purged into a reservoir of the refrigeration subsystem 110. For instance, response signal 162 can cause a compressor subunit 142, or other pump, of the refrigeration subsystem 110 to pump the flammable refrigerant 125 to a condenser subunit 138 of the subsystem 110, e.g., where the condenser subunit 138 located outdoors. Based on the present disclosure one of ordinary skill would appreciate how the flammable refrigerant 120 could be purged into other device subunits (e.g., a separator 140 and/or aggregator 144) which could serve as refrigerant reservoirs.

In some embodiments, the response signal 162 can be configured to cause the activation of an airflow device 119 (e.g., a furnace blower) configured to mix or vent leaked portions of the flammable refrigerant 125.

In some embodiments, the response signal 162 can be configured to cause one or more devices of the space conditioning system 100 to cease operating. For instance, consider the case where the refrigeration subsystem 110 is an air-conditioning subsystem for a HVAC space conditioning system 100. During some periods of the year (e.g., winter) the refrigeration subsystem 110 is not on, and the space conditioning system 100 is in heating mode. A flammable refrigerant 120 leak may still occur during such periods, and if a leak occurs during such periods, it is still desirable to stop operating or not further turn on other devices of the space conditioning system 100, such as a furnace 175, that could cause the leaking refrigerant to ignite. For instance, the response signal 162 can cause a stoppage of electrical power or fuel (e.g., natural gas or propane) to the furnace 175, or other devices of the system 100.

In some embodiments, the response signal 162 can be configured to cause one or more devices of the space conditioning system 100 cause an airflow device 119 (e.g., a furnace blower or other air flow device) of the space conditioning system 100 to circulate air prior to firing a furnace 175 of the space conditioning system 100. For instance, in some cases leaked flammable refrigerants 120 that are heavier than air may settle into a location (e.g., the duct work of a furnace or air handler) that is remote from the leak detector 115. In such cases it is desirable to mix or vent these refrigerants from their settled locations so as to facilitate their detection. For instance by turning on indoor blower 119 of the furnace 175 air can be sufficiently disturbed to cause the flammable refrigerants 120 to reach the leak detector 115. Turning on a furnace air blower before firing the furnace is counter-intuitive because typically the opposite sequence of operations is performed: the furnace burner is turned on before the blower 119 is turned on.

As noted above, in some embodiments, the leak-detector subunit 115 can include multiple sensors 150 configured to detect refrigerant in different parts of the subsystem 110, such as e.g., in the vicinity of coils of the evaporator 134 or flow lines 130 carrying the refrigerant 120. In some case the sensors 150 can be located in other parts of the system 100, or in the enclosed space 105, as well.

In some cases, the leak-detector subunit 115 or one or more of its sensors 150 can be inside of the enclosed space 105, or, outside of the enclosed space 105, or both inside and outside of the enclosed space 105. For instance, when the enclosed space 105 is the interior of a building the refrigeration subsystem 110 may be located in a closet, basement or other portion of the enclosed space 105 and the leak-detector subunit 115 or one or more of its sensors 150 may be located near the refrigeration subsystem 110 in the closet or other port of the enclosed space.

In some cases, part of the refrigeration subsystem 110 (e.g., the evaporator subunit 134) may be inside the enclosed space 105 and other parts (e.g., a compressor subunit 142 or condenser subunit 138 may be outside of the enclosed space 105 (e.g., a roof top of the enclosed space 105). In such cases the leak detector subunit 115, or one or more of its sensors 150, 151 may be located inside the evaporator subunit 134 or other subunits of the refrigeration subsystem 110, e.g., adjacent to coils of the evaporator 134 that are configured to carry the flammable refrigerant 120:

In some cases, such as when the enclosed space 105 is the interior cooling compartment of a freezer or refrigerator, the leak-detector subunit 115, may be entirely outside of the enclosed space 105, e.g., in an attic, basement, closet, or other compartment housing all or parts of the refrigeration subsystem, and/or on or adjacent to the outer surface of the refrigeration subsystem 110.

In some embodiments, the leak-detector subunit 115 includes a gas sensor 150 located within the refrigeration subsystem 110, the gas sensor configured to detect a gaseous state of the flammable refrigerant 120. For instance, if the flammable refrigerant 120 is or includes propane, then leak-detector subunit 115 can include a propane gas sensor 150 such as the SAFE-T-ALERT™ Propane and Methane detector (MODEL 40-441A MODEL 40-442A USER'S MANUAL, MTI Industries, Inc, Volo, Ill., incorporator herein in its entirety), or, a hydrocarbon detector, volatile organic compound detector or other, combustible gas detectors such manufactured by Murco Gas Detection (Dublin Ireland).

In some embodiments, the leak-detector subunit 115 includes a flow sensor 151 configured to measure a rate of flow of the flammable refrigerant 120 through a flow line 130 of the refrigeration subsystem 110 through which the flammable refrigerant 120 is circulated.

In some embodiments the leak-detector subunit 115 is configured to continuously detect for the leakage of the flammable refrigerant 120. For instance, in some cases the leak-detector subunit 115 has sensors 150, 151 that continuously measure for a concentration of gaseous flammable refrigerant 120 or measure the flow rate of flammable refrigerant 120 through a flow line 130, and, the leak-detector subunit 115 sends a continuous signal to the control subunit. A change in the continuous signal (e.g., signifying an increase in gaseous concentration or decrease in flow rate of flammable refrigerant), beyond a predefined threshold, corresponds to the alarm signal 125. In other cases, the alarm signal 125 is a discrete signal generated only when an increased concentration of gaseous, or decreased flow rate, of flammable refrigerant 120 is detected beyond the predefined threshold.

In other cases, the accumulation of detectable gaseous flammable refrigerant over a certain period of time (e.g., 1, 5 or 60 minute) beyond a predefined threshold, can cause the alarm signal 125 to be initiated.

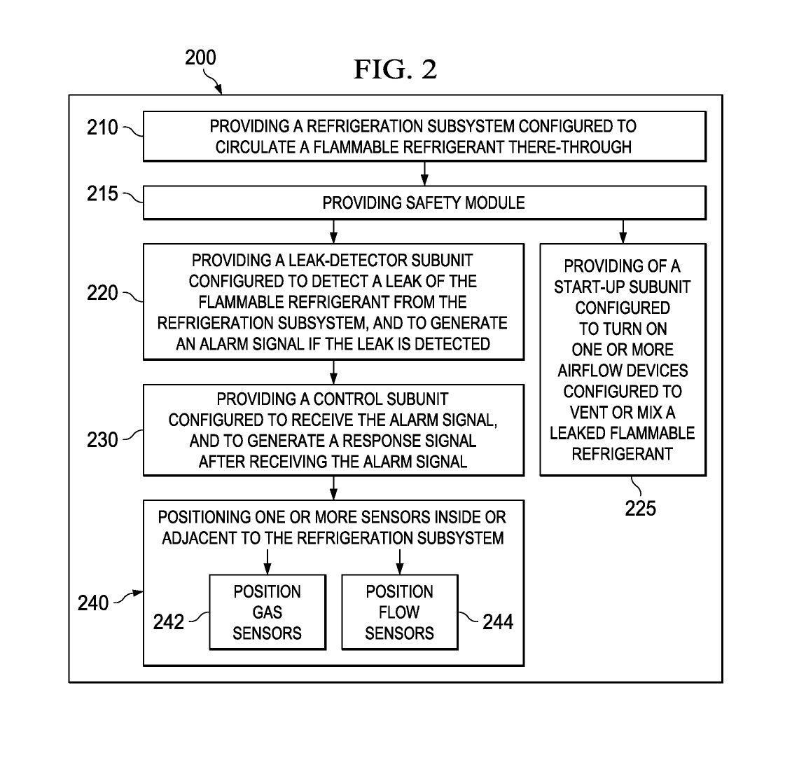

Another embodiment of the present disclosure is a method of assembling a space conditioning system. FIG. 2 presents a flow diagram of an example method 200 of assembling a space conditioning system such as any embodiments of the space conditioning systems 110 discussed in the context of FIG. 1.

With continuing reference to FIG. 1 throughout, the example method 200 presented in FIG. 2 includes a step 210 of providing a refrigeration subsystem 110 configured to circulate a flammable refrigerant 120 there-through. The method also includes a step 215 of providing safety module 112 that includes either: a step 220 of providing a leak-detector subunit 115 configured to detect a leak of the flammable refrigerant 120 from the refrigeration subsystem 110, and, to generate an alarm signal 125 if the leak is detected, or, a step 225 providing of a start-up subunit 117 configured to turn on one or more airflow devices 119 configured to vent or mix a leaked flammable refrigerant 120. That is, the step 225 is performed regardless of whether there is an indication of the presence of leaked flammable refrigerant or not.

In some embodiments, as part of providing the safety module 112 in step 215, both the leak-detector subunit 115 and the start-up subunit 117 are provided in steps 220 and 225, respectively.

Some embodiments of the method 200 can further include a step 230 of providing a control subunit 160 configured to receive the alarm signal 125, and to generate a response signal 162 after receiving the alarm signal 125. Some embodiments of the method can further include a step 240 of positioning one or more sensors 150, 151 of the leak detector subunit 115, inside or adjacent to the refrigeration subsystem 110. For instance, as part of step 240 gas sensors 150 can be positioned, in step 242, adjacent to various components of the refrigeration subsystem 110, the gas detector 150 configured to detect a gaseous state of the flammable refrigerant 120. For instance, as part of step 240 flow rate sensors 151 can be positioned, in step 244, within a flow path of the refrigeration subsystem 110 that is configured to circulate the flammable refrigerant 120 there-through.

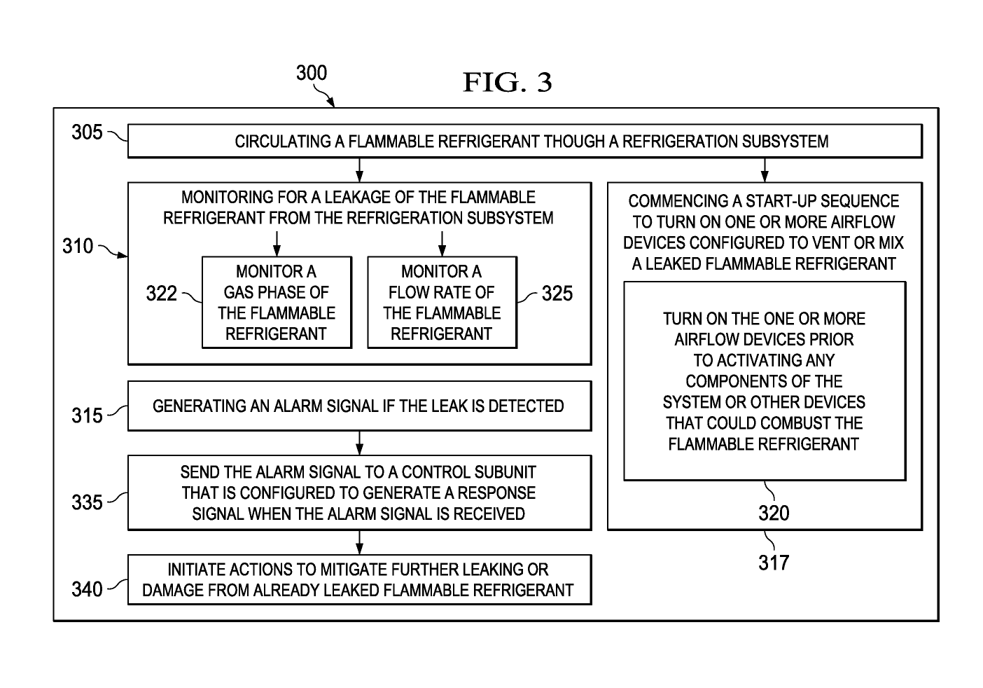

Another embodiment of the present disclosure is a method of conditioning air within an enclosed space. FIG. 3 presents a flow diagram of an example method 300 of conditioning air within an enclosed space 105, such as implemented by any of the embodiments of the space conditioning systems 100 discussed in the context of FIGS. 1 and 2.

With continuing reference to FIG. 1 throughout, the example method 300 presented in FIG. 3 includes, a step 305 of circulating a flammable refrigerant 120 though a refrigeration subsystem 110, (e.g., via safety module 112) either a step 310 of monitoring for a leakage of the flammable refrigerant 120 from the refrigeration subsystem 110 (e.g., via a leak detector subunit 115) and a step 315 of generating an alarm signal 125 if the leak is detected (e.g., via the leak detector subunit 115), or, a step 317 of commencing a start-up sequence (e.g., via a start-up subunit 117) to turn on one or more airflow devices 119 configured to vent or mix a leaked flammable refrigerant 120.

In some embodiments, both the monitoring for the leakage of the flammable refrigerant in step 310 and the start-up sequence in step 317 are commenced, prior to activating any components of the space conditioning system 110.

In some embodiments the step 317 that includes turning on the one or more airflow devices 119 is done, in step 320, prior to activating any components of the system, or other devices, that could combust the flammable refrigerant.

In some embodiments, the step 310 of monitoring for a leakage can further include a step 322 of monitoring for a gaseous phase of the flammable refrigerant 120, e.g., via the appropriate sensor 150 position to measure leaks from components of the refrigeration subsystem 110, or, leakage into a space 105 cooled by the refrigeration subsystem 110.

In some embodiments, the step 310 of monitoring for a leakage can further include a step 325 of includes monitoring for a change in the flow rate of the flammable refrigerant 120 circulating through the refrigeration subsystem 110 (e.g., a decrease in flow rate through flow lines 130 or other components of the subsystem 110).

In some embodiments, the method 300 can further include a step 335 of sending the alarm signal to a control subunit 160 that is configured to generate a response signal 162 when the alarm signal 125 is received.

The response signal 162, in turn, can be configured to initiate a number of different actions, in step 340, to mitigate further leaking or damage from already leaked flammable refrigerant 120.

For instance, as part of step 340, the response signal 162 can cause one or more refrigerant flow control devices 132 (e.g., pumps or valves) to actuate such that the flammable refrigerant 120 has reduced, or no, circulation through the refrigeration subsystem 110. For instance, the response signal 162 can cause a compressor 142 of the refrigeration subsystem 110 to stop pumping the flammable refrigerant 120 to a condenser 138 of the refrigeration subsystem 110. For instance, the response signal 162 can cause one or more valves 132 actuate so as to stop the circulation of the flammable refrigerant 120 through the refrigeration subsystem 110 so as to isolate or lock the flammable refrigerant 120 in the outdoor unit of the subsystem 110, and thereby prevent the flow of further flammable refrigerant 120 to the section of the refrigeration subsystem 110 where the leak was detected. Or, the response signal 162 can causes one or more refrigerant flow control device 132 (to actuate such that the flammable refrigerant 120 is purged into a reservoir of the refrigeration subsystem 110, to prevent the flow of further flammable refrigerant 120 to the section of the refrigeration subsystem 110 where the leak was detected.

For instance, as part of step 340, the response signal 162 can cause one or more airflow device 119 to vent leaked portions of the flammable refrigerant away from the refrigeration subsystem 110.

For instance, as part of step 340, the response signal 162 can cause an airflow device 119 of the space conditioning system 100 to circulate air prior to firing a furnace subunit 175 the space conditioning system 100. For instance, when the space conditioning system 100 is or includes an air conditioning system for a building and the system 100 includes a furnace 175, the response signal 162 can cause the indoor blower 119 of the furnace 119 to run so as to disturb heavier-than-air refrigerant 120.

For instance, as part of step 340, the response signal 162 can cause one or more one or more component parts of the space conditioning system 100 to cease operating, e.g., by turning off electric power and heating fuel to the subsystem 110 or to other components of the system 100 (e.g., a furnace 175). For instance, the response signal 162 can cause the stoppage of operation of a gas furnace 175, if currently in operation, terminate or lockout the operation of furnace 175 if currently not in operation, and turn off natural gas flow, or electricity to support electric heating, to the furnace 175.

For instance, as part of step 340, the response signal 162 can cause an indoor blower 119 or other airflow device of the space conditioning system 100, to run so as to dilute concentration of leaked flammable refrigerant 120 in the enclosed space 105, or, in the structure 107 containing all or part of the subsystem 110 (e.g., the attic, closet space or basement space).

Those skilled in the art to which this application relates will appreciate that other and further additions, deletions, substitutions and modifications may be made to the described embodiments.

What is claimed is:

1. A space conditioning system for conditioning air within an enclosed space, comprising:
a refrigeration subsystem configured to circulate a flammable refrigerant there-through; and
a safety module configured to include either:
a leak-detector subunit configured to monitor for a leak of the flammable refrigerant from the refrigeration subsystem, and, to generate an alarm signal if the leak is detected, or,
a start-up subunit configured to turn on one or more airflow devices configured to vent or mix a leaked flammable refrigerant.

2. The system of claim 1, wherein the safety module includes both the leak-detector subunit and the start-up subunit.

3. The system of claim 1, wherein the start-up subunit is configured to turn on the one more airflow devices prior to activating any component of the space conditioning system or other component capable of causing the flammable refrigerant to combust.

4. The system of claim 1, wherein the alarm signal is configured to cause a display subunit of the space conditioning system to present an alarm indication.

5. The system of claim 1, further including a control subunit configured to receive the alarm signal, and, to generate a response signal after receiving the alarm signal.

6. The system of claim 5, wherein the response signal is configured to cause the flammable refrigerant to have reduced circulation through the refrigeration subsystem.

7. The system of claim 5, wherein the response signal is configured to cause a charge of the flammable refrigerant to become inaccessible to a part of the refrigeration subsystem where the alarm signal originated from.

8. The system of claim 5, wherein the response signal is configured to cause the flammable refrigerant to be purged into a reservoir of the refrigeration subsystem.

9. The system of claim 5, wherein the response signal is configured to cause the activation of one or more of the airflow device configured to mix or vent leaked portions of the flammable refrigerant.

10. The system of claim 5, wherein the response signal is configured to cause one or more devices of the space conditioning system to cease operating.

11. The system of claim 5, wherein the control subunit is configured to cause the airflow device of the space conditioning system to circulate air prior to firing a furnace of the space conditioning system.

12. The system of claim 1, wherein the leak-detector subunit includes a gas sensor located within the refrigeration subsystem, the gas sensor configured to detect a gaseous state of the flammable refrigerant.

13. The system of claim 1, wherein the leak-detector subunit includes a gas sensor located outside of the refrigeration subsystem but in the vicinity of the refrigeration subsystem, the gas sensor configured to detect a gaseous state of the flammable refrigerant.

14. The system of claim 1, wherein the leak-detector subunit includes a flow sensor configured to measure a rate of flow of the flammable refrigerant through a flow line of the refrigeration subsystem through which the flammable refrigerant is circulated.

15. The system of claim 1, wherein the refrigeration subsystem is configured as an air-conditioning system for a building, home or motor vehicle.

16. A method of assembling a space conditioning system, comprising:
providing a refrigeration subsystem configured to circulate a flammable refrigerant there-through; and
providing a safety module that includes either:
providing a leak-detector subunit configured to detect a leak of the flammable refrigerant from the refrigeration subsystem, and, to generate an alarm signal if the leak is detected, or
providing a start-up subunit configured to turn on one or more airflow devices configured to vent or mix a leaked flammable refrigerant.

17. A method of conditioning air within an enclosed space, comprising:
circulating a flammable refrigerant though a refrigeration subsystem; and either:
monitoring for a leakage of the flammable refrigerant from the refrigeration subsystem and generating an alarm signal if the leak is detected, or
commencing a start-up sequence to turn on one or more airflow devices configured to vent or mix a leaked flammable refrigerant.

18. The method of claim 17, wherein both the start-up sequence is commenced and the monitoring for the leakage of the flammable refrigerant is started prior to activating any components of the space conditioning system.

19. The method of claim 17, wherein the monitoring for the leakage includes monitoring for a gaseous phase of the flammable refrigerant, or, monitoring for a change in the flow rate of the flammable refrigerant circulating through the refrigeration subsystem.

20. The method of claim 17, further including sending the alarm signal to a control subunit that is configured to generate a response signal when the alarm signal is received.
